(19) United States
(12) Patent Application Publication
(10) Pub. No.: US 2009/0087594 A1
(43) Pub. Date: Apr. 2, 2009

(54) Additives for use in print media to reduce bronzing

(76) Inventors: Palitha WICKRAMANAYAKE, Corvallis, OR (US); Matthew THORNBERRY, Corvallis, OR (US); Linda C. UHLIR-TSANG, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/248,323

(22) Filed: Oct. 9, 2008

Related U.S. Application Data
(62) Division of application No. 10/417,243, filed on Apr. 15, 2003, now abandoned.

(51) Int. Cl. B41M 5/50

(52) U.S. Cl. 428/32.1

(57) ABSTRACT

An additive used in a print medium to reduce bronzing. The additive increases a pH of the print medium. The additive is an organic base or an inorganic base. The additive reduces bronzing of an image printed with a dye-based inkjet ink.

### FIELD OF THE INVENTION

The present invention relates to a print medium for use in inkjet printing and, more specifically, to a print medium that exhibits reduced bronzing.

### BACKGROUND OF THE INVENTION

The use of inkjet printers and inkjet printing systems in offices and homes has grown dramatically in recent years. The growth can be attributed to drastic reductions in the cost of inkjet printers and substantial improvements in print resolution and overall print quality. At present, inkjet printers are able to print on various types of print media, such as plain paper, transparencies, and specialty paper. Improvements in various print attributes on these print media are continually sought. While print media suitable for use in digital printing have been developed, research and development efforts continue toward improving the print quality on these print media.

Image quality of a photographic image is a function of both the inkjet ink and the print medium upon which the image is printed. Important attributes of a photographic-quality image include saturated colors, high gloss and gloss uniformity, freedom of grain and coalescence, and a high degree of image permanence, to name a few. However, with current print media, printed images commonly have undesirable attributes.

One such undesirable attribute, bronzing, is an optical phenomenon resulting in a metallic luster that is observed when the printed image is viewed at a particular angle. Additionally, the hue is usually changed from that of the intended hue and a reduction in gloss and optical density may also result. In the case of images printed with dye-based inkjet inks, bronzing is believed to be due to the presence of dye aggregates or crystals forming on the surface of the print medium. While bronzing is most noticeable with black inks, color inks also exhibit bronzing. With color inks, bronzing is more noticeable as the color density gets higher, such as in the case of secondary colors. Reducing or eliminating bronzing of the printed image contributes to higher gloss and better gloss uniformity.

To reduce bronzing, modifications to the print medium or to the inkjet ink have been proposed. For example, use of an inkjet recording element having polymeric particles has been disclosed. The polymeric particles, such as acrylic or styrenic monomers, are typically added to an image-forming layer of the inkjet recording element. Furthermore, to reduce bronzing, the pH of the image-forming layer is adjusted to 8.5.

Other solutions to the bronzing problem have been proposed. For example, use of inkjet compositions having an additive to reduce surface tension have been disclosed. To reduce bronzing in these inkjet compositions, multiple dyes are used and buffers are optionally added to adjust the pH of the inkjet composition to 7-9.5. Also disclosed are ink compositions having a dye that includes an ammonium ion as a counterion and an ammonium salt of an inorganic or organic acid. These ink compositions also include an alkali metal salt to improve the stability of the ink.

Use of pigment-based ink compositions have also been disclosed. Such ink compositions typically include a water-soluble precursor that is converted to an insoluble pigment by chemical means, thermal means, photodecomposition means, and/or radiation means. The chemical means include a pigment-formation promoter compound that is present on the print medium and reacts with the precursor. The pigment-formation promoter compound is an organic acid, an organic base, an inorganic acid, or an inorganic base. The pigment-based ink composition exhibits reduced bronzing when printed on the print medium having the pigment formation promoter compound.

It would be desirable to provide print media that have reduced bronzing of images printed with dye-based inkjet inks.

### BRIEF SUMMARY OF THE INVENTION

A method for producing a print medium having reduced bronzing is also disclosed. The method comprises incorporating an additive into the print medium, where the additive increases the pH of the print medium.

The present invention relates to a method of reducing bronzing in a printed image is also disclosed. The method comprises raising a pH of the print medium by incorporating an additive into the print medium.

### DETAILED DESCRIPTION OF THE INVENTION

An additive is incorporated into a print medium to reduce or eliminate bronzing of an image printed on the print medium. The additive may include an organic or inorganic base. While the examples and embodiments discussed herein describe the print medium as having one additive, it is contemplated that more than one additive may be incorporated into the print medium. For example, a mixture of organic bases, a mixture of inorganic bases, or a mixture of organic bases and inorganic bases may be used in the print medium. The purity of all components is the purity used in normal commercial practice for inkjet printing.

To reduce bronzing, the pH of the print medium may be increased relative to the pH of an untreated print medium. The pH may be increased by incorporating the additive into a conventional print medium having either an acidic pH or a basic pH. For example, if a print medium having an acidic pH is used, the pH of the print medium may be increased so that it is less acidic or even basic. If a print medium having a basic pH is used, the pH of the print medium may be increased so that it becomes more basic. The degree to which the additive increases the pH of the print medium and, therefore, reduces bronzing, may depend on the base strength of the additive. The reduction in bronzing may also depend on the nature of the print medium and the dye used in the inkjet ink. In other words, the increase in pH required to reduce or eliminate bronzing for one print medium and dye may differ from the increase in pH required for a different dye on the same print medium or the same dye on a different print medium. The increased pH of the print medium may also improve gloss and reduce bronzing due to reduced dye crystallization on the surface of the print medium. The increase in pH may also favorably improve hue and result in chroma boosts.

The organic base may include, but is not limited to, 4-morpholineethane-sulfonic acid (“MES”); bis(2-hydroxyethyl)imino-tris(hydroxymethyl)methane (“Bis-Tris”); N-(2-acetamido)imino-diacetic acid (“ADA”); N-(2-acetamido)-2-aminoethanesulfonic acid (“ACES”); piperazine-N N′-bis(2-ethanesulfonic acid) (“PIPES”); beta-hydroxy-4-morpholinepropanesulfonic acid (“MOPSO”); 1,3-bis(tris(hydroxymethyl)methylamino)-propane (“Bis-Tris propane”); N,N-bis(2-hydroxyethyl)-2-aminoethanesulfonic acid (“BES”); 4-(N-morpholino)butanesulfonic acid (“MOBS”); N-tris(hydroxymethyl)methyl-2-aminoethane sulfonic acid (“TES”); N-(2-hydroxyethyl)piperazine-N′-2-ethanesulfonic acid (“HEPES”); N,N-bis(2-hydroxyethyl)-3-amino-2-hydroxypropanesulfonic acid (“DIPSO”); 4-morpholinepropanesulfonic acid (“MOPS”); 3-(N-tris(hydroxymethyl)methylamino)-2-hydroxypropane-sulfonic acid (“TAPSO”); tris(hydroxymethyl)aminomethane (“TRIZMA®”); N-(2-hydroxyethyl)piperazine-N′-(2-hydroxypropane-sulfonic acid)) (“HEPPSO”); piperazine-N,N′-bi(2-hydroxypropanesulfonic acid)) (“POPSO”); triethanolamine (“TEA”); N-(2-hydroxyethyl)piperazine-N′-(3-propanesulfonic acid) (“EPPS”); N-(tris(hydroxymethyl)methyl)glycine (“Tricine”); glycyl-glycine (“gly gly”); N,N-bis(2-hydroxyethyl)glycine (“Bicine”); N-(2-hydroxyethyl)piperazine-N′-(4-butanesulfonic acid) (“HEPBS”); ((2-hydroxy-1,1-bis(hydroxymethyl)ethyl)amino)-1-propanesulfonic acid (“TAPS”); 2-amino-2-methyl-1,3-propanediol (“AMPD”); N-tris-(hydroxymethyl)methyl-4-aminobutanesulfonic acid (“TABS”); 3-((1,1-dimethyl-2-hydroxyethyl)amino)-2-hydroxypropanesulfonic acid (“AMPSO”); 2-(cyclohexylamino)ethanesulfonic acid (“CHES”); 3-(cyclohexylamino)-2-hydroxy-1-propanesulfonic acid (“CAPSO”); 2-amino-2-methylpropanol (“AMP”); 3-cyclohexylamino-1-propanesulfonic acid (“CAPS”); 4-cyclohexylamino-1-butanesulfonic acid (“CABS”); sodium acetate; and sodium succinate, all of which are available from Sigma-Aldrich Corp. (St. Louis, Mo.).

The inorganic base may include, but is not limited to, sodium bicarbonate, sodium carbonate, sodium borate, sodium phosphate, sodium acetate, sodium sulfite, sodium bisulfite, and sodium hydroxide, all of which are available from Sigma-Aldrich Corp. (St. Louis, Mo.). In addition to using sodium, it is contemplated that other counterions may be used including, but not limited to, potassium and lithium.

The additive may be present in the print medium in an amount sufficient to reduce bronzing without negatively affecting desirable properties of the print medium. For instance, the additive may be present in the print medium from approximately 0.001% to approximately 20% by weight of the total coating formulation. Preferably, the additive is present in the print medium in an amount from approximately 0.001% to approximately 5% by weight. Most preferably, the additive is present in an amount from approximately 0.001% to approximately 3% by weight.

The print medium may be a plain paper or a specialty paper, such as a coated paper, a glossy paper, a nanoporous print medium, or a photographic paper. Preferably, the print medium is a conventional photographic paper for use in digital printing. The print medium may be opaque, translucent, or transparent and may include a support layer and an ink-receptive layer. The support layer may include, but is not limited to, a plain paper, a resin-coated paper, a plastic (e.g. a polyester-type resin such as poly(ethylene terephthalate), poly(ethylene naphthalate) and polyester diacetate), a polycarbonate-type resin, a fluorine-type resin (e.g. polytetrafluoroethylene), a metal foil, a glass material, and the like. If the support layer is transparent, a transparent print medium may be obtained and used as a transparency in an overhead projector. The support layer may have a thickness of about 12 μm to about 500 μm, and preferably from about 75 μm to about 300 μm.

The ink-receptive layer of the print medium may be a single layer or a multilayer coating that absorbs large quantities of inkjet ink, which is necessary to print high quality, photographic images. The ink-receptive layer may include a conventional porous or swellable coating and may further include polymeric binders, such as water-soluble polymeric binders or water-dispersible resins. Suitable water-soluble polymeric binders may include, but are not limited to, poly(2-ethyl-2-oxazoline), poly(vinyl pyrrolidone), vinyl pyrrolidone copolymers, poly(ethylene oxide), starch, casein, sodium alginate, gelatin, gum arabic, and cellulose derivatives. Suitable water-dispersible resins may include, but are not limited to, polyacrylates, polymethacrylates, polyurethanes, polyvinyl acetate, polyvinyl chloride, styrene, styrene and maleic acid anhydride copolymers.

The print medium may be formed in a one-step process, where the ink-receptive layer and the support layer are coextruded, stretched, and integrally connected during formation. Alternatively, the ink-receptive layer and the support layer may be formed separately and adhered to each other by conventional techniques known in the art. In addition, a coating formulation of the ink-receptive layer may be coated onto the support layer by conventional coating techniques that include, but are not limited to, blade coating, air knife coating, rod coating, wound wire rod coating, roll coating, slot coating, slide hopper coating, gravure, and curtain coating. The coating formulation may also include optional components such as fade inhibitors, plasticizers, or surfactants.

The additive may be incorporated into the print medium by placing the print medium in a solution that includes the additive. Alternatively, the additive may be mixed into a coating formulation of one of the layers of the print medium, such as the ink-receptive layer. These techniques of incorporating the additive into the print medium provide a simple, cost-effective solution to reduce bronzing. The additive may be incorporated into the print medium by placing the print medium in a wash coat that includes the additive. The wash coat may be formed by dissolving the additive in water, an alcohol, or a mixture thereof, depending on the solubility of the additive. The wash coat may include the additive in a sufficient concentration to provide the desired weight percentage of additive in the print medium. For example, the concentration of additive in the wash coat may be as high as approximately 50% by weight. The print medium may be placed in the wash coat for a sufficient amount of time for the additive to be incorporated into the print medium. It is also contemplated that the wash coat may be sprayed onto the print medium. The print medium may be dried by allowing the solvent to evaporate or by heating the print medium to remove the solvent.

Depending on the type of print medium and the technique used to incorporate the additive into the print medium, the additive may impregnate a portion of the print medium or may diffuse throughout the print medium. Regardless of the depth of penetration achieved, the additive may be homogenously incorporated into the print medium.

The desired image may be printed onto the print medium using a conventional inkjet printer and conventional inkjet inks. The inkjet ink may include a solvent or carrier liquid and at least one dye or pigment. Preferably, a dye-based inkjet ink is used. The inkjet ink may optionally include humectants, organic solvents, detergents, thickeners, and/or preservatives, depending on the desired properties of the inkjet ink. The dye may be a water-soluble acid, direct, food, mordant, or reactive dye including, but not limited to, a sulfonate or carboxylate dye The inkjet ink may be applied to, or printed on, the print medium by a drop-on-demand or continuous printing technique. In one embodiment, the image is printed on a photographic paper using digital printing.

After the desired image is printed, bronzing may be qualitatively determined by visually observing the printed image after the inkjet ink has dried. Since bronzing may be most apparent in thin lines and around edges of solid patches of the inkjet ink, a block-shaped image may be printed. In addition, a quantitative determination of bronzing may be conducted by determining a change in hue angle of the printed image.

The following examples further illustrate the present invention.

### EXAMPLES

### Example 1

### Preparation of Print Media Treated with Organic and Inorganic Bases

A 10% aqueous solution of each of the additives listed in Table 1 was prepared. Each of these solutions was sprayed onto a surface of a photographic print medium that was coated with a porous ink-receptive layer to produce ten treated print media. The print media had an untreated surface pH of 4.2. The treated print media were allowed to dry overnight in an oven set at 40° C.

TABLE 1
Bronzing, pH and Hue Angle Measured on Treated Print Media.

| | | pH of Print | |
|---|---|---|---|
| | | Medium | |
| | Bronzing | After | |
| Additive | Rating | Treatment | Hue Angle |
| NaHCO₃ | 10 | 10.3 | 229.2 |
| Na₂C0₃ | 9 | 10.3 | 229.3 |
| Na₂B₄O₇ | 8.5 | 8.8 | 228.1 |
| NaOAc | 8 | 8.0 | 227.7 |
| Na₂HPO₄ | 8 | 7.9 | 228.2 |
| Na₂SO₃ | 7 | 6.8 | 226.3 |
| NaHSO₃ | 6 | 6.3 | 226.5 |
| Na₂S₂O₃ | 6 | 6.0 | 226.5 |
| Na Succinate | 7 | 6.0 | 226.9 |
| NaOH | 9 | 5.4 | 227.8 |
| Control (no additive) | 6 | 4.2 | 225.4 |

### Example 2

### Determination of Bronzing of a Cyan Inkjet Ink

A cyan, dye-based inkjet ink was used to print a block-shaped image of varying ink densities on the treated print media described in Example 1 and on a control (untreated) print medium. The ability of the treated print media to reduce bronzing was determined by visually comparing the printed image on each treated print medium to the printed image on the control print medium. Bronzing was ranked on a scale of 1 to 10, with 10 representing no bronzing.

As shown in Table 1, the print media treated with sodium bicarbonate, sodium carbonate, sodium borate, sodium hydrogen phosphate, sodium acetate, or sodium hydroxide showed reduced bronzing compared to the control print medium. The treated print media all exhibited an increase in surface pH, as measured by conventional techniques, compared to the control print medium.

The changes in hue angle were measured by conventional techniques using a Gretag Macbeth spectrophotometer. As shown in Table 1, the treated print medium exhibited hue angle changes towards blue.

### Example 3

### Preparation of Print Media Treated with Additional Organic and Inorganic Bases

A 10% aqueous solution of each of the following thirty-two bases is prepared: MES, Bis-Tris, ADA, ACES, PIPES, MOPSO, Bis-Tris Propane, BES, MOPS, TES, HEPES, DIPSO, MOBS, TAPSO, TRIZMA, HEPPSO, POPSO, TEA, EPPS, Tricine, gly gly, Bicine, BEPBS, TAPS, AMPD, TABS, AMPSO, CHES, CAPSO, AMP, CAPS, and CABS. Each of these solutions is sprayed onto a surface of a photographic print medium coated with a porous ink-receptive layer to produce thirty-two, treated print media (one base per print medium). The untreated print media have a surface pH of 4.2. The treated print media are allowed to dry in an oven set at 40° C. overnight.

### Example 4

### Determination of Bronzing of a Cyan Inkjet Ink

A cyan, dye-based inkjet ink is used to print a block-shaped image of varying ink densities on each of the treated print media described in Example 3 and on a control (untreated) print medium. The extent of bronzing is determined by visually observing the printed image. Bronzing is ranked on a scale of 1 to 10, with 10 representing no bronzing. Changes in hue angle are also measured.

The treated print media will exhibit reduced bronzing compared to the control print medium.

### Example 5

### Determination of Bronzing of Magenta, Yellow, and Black Inkjet Inks

Magenta, yellow, and black dye-based inkjet inks are used to print block-shaped images of varying ink densities on each of the treated print media described in Examples 1 and 3. The images printed with these inkjet inks will exhibit reduced bronzing compared to the control print medium.

While the invention may be susceptible to various modifications and alternative forms, specific embodiments have been shown by way of example and have been described in detail herein. However, it should be understood that the invention is not intended to be limited to the particular forms disclosed. Rather, the invention is intended to cover all modifications, equivalents, and alternatives failing within the spirit and scope of the invention as defined by the following appended claims.

1-21. (canceled)

22. A print medium of having reduced bronzing comprising:
a support layer;
a porous ink-receptive layer on the support layer, the porous ink-receptive layer comprising at least one of a porous coating, a swellable coating, a polymeric binder, and a water-dispersable resin;
at least one additive substantially homogenously incorporated into the porous ink-receptive layer by applying a solution comprising less than or equal to 50% by weight of the additive dissolved in water to the ink-receptive layer, wherein the at least one additive is selected from the group consisting of bis(2-hydroxyethyl)imino-tris(hydroxymethyl)methane; N-(2-acetamido)imino-diacetic acid; N-(2-acetamido)-2-aminoethanesulfonic acid; piperazine-N,N′-bis(2-ethanesulfonic acid); beta-hydroxy-4-morpholinepropanesulfonic acid; 1,3-bis(tris(hydroxymethyl)methylamino)-propane; N,N-bis(2-hydroxyethyl)-2-aminoethanesulfonic acid; 4-(N-morpholino)butanesulfonic acid; N-(2-hydroxyethyl)piperazine-N′-2-ethanesulfonic acid; N,N-bis(2-hydroxyethyl)-3-amino-2-hydroxypropanesulfonic acid; 4-morpholinepropanesulfonic acid; 3-(N-tris(hydroxymethyl)methylamino)-2-hydroxypropane-sulfonic acid; N-(2-hydroxyethyl)piperazine-N′-(2-hydroxypropane-sulfonic acid)); piperazine-N,N′-bis(2-hydroxypropanesulfonic acid)); N-(2-hydroxyethyl)piperazine-N′-(3-propanesulfonic acid); N-(tris(hydroxymethyl)methyl)glycine; glycyl-glycine; N-(2-hydroxyethyl)piperazine-N′-(4-butanesulfonic acid); ((2-hydroxy-1,1-bis(hydroxymethyl)ethyl)amino)-1-propanesulfonic acid; 2-amino-2-methyl-1,3-propanediol; N-tris-(hydroxymethyl)methyl-4-aminobutanesulfonic acid; 3-((1,1-dimethyl-2-hydroxyethyl)amino)-2-hydroxypropanesulfonic acid; 2-(cyclohexylamino)ethanesulfonic acid; 3-(cyclohexylamino)-2-hydroxy-1-propanesulfonic acid; 2-amino-2-methylpropanol; 3-cyclohexylamino-1-propanesulfonic acid; 4-cyclohexylamino-1-butanesulfonic acid; sodium acetate; and sodium succinate, and wherein the porous ink-receptive layer and the additive comprise a total coating formulation.

23. (canceled)

24. The print medium of claim 22, wherein the at least one additive is present in the print medium in an amount from approximately 0.001% to approximately 20% by weight of a total coating formulation.
